(19) United States
(12) Patent Application Publication
(10) Pub. No.: US 2014/0130555 A1
(43) Pub. Date: May 15, 2014

(54) DATA PORT LOCK

(71) Applicant: Jeff Clark, Harvest, AL (US)

(72) Inventor: Jeff Clark, Harvest, AL (US)

(21) Appl. No.: 13/678,228

(22) Filed: Nov. 15, 2012

(51) Int. Cl. E05B 73/00

(52) U.S. Cl. CPC E05B 73/00
USPC 70/58

(57) ABSTRACT

A system and method for securing an information access port includes:

a locking assembly constructed and arranged to be removably placed into an information access port;

a locking assembly holder, whereby said locking mechanism holder is constructed and arranged with at least one locking device whereby said locking device controls placement and subsequent removal of said locking assembly.

### BACKGROUND OF THE INVENTION

Electronic devices have created a world in which information exchanged has become quite commonplace.

Devices such as flash media and the like have made the sharing of information quite easy. However, a difficulty arises when a person wishes to secure information on an electronic or electronic computing device. Most of these devices have external access ports whereby they are constructed and arranged for the ease of sharing information. There have been attempts at producing lock systems for these various information inlet ports, but these lock mechanisms have met with varying levels of success. One difficulty arises in that it has become difficult to configure a device, which not only fills the space of a receiving inlet port, but also locks and secures into that space such that it can only be removed by application of a removable key. The present invention is a system whereby a lock mechanism is inserted into an inlet for a data port and a mechanism applicator uses lock and key technology in order to securely place the locking mechanism into position. The locking mechanism can be locked into position and subsequently unlocked only by using an applicator with a lock/unlock mechanism.

### SUMMARY OF THE INVENTION

In one embodiment, the present invention is a system for securing an information access port, said system comprising:

a locking assembly constructed and arranged to be removably placed into an information access port;

a locking assembly holder, whereby said locking mechanism holder is constructed and arranged with at least one locking device whereby said locking device controls placement and subsequent removal of said locking assembly.

The locking assembly has incorporated therein at least one moveable latch for securing said locking mechanism into an access port. In one embodiment, the moveable latch is urged into the lock position by a living hinge. Alternatively, the latch can be controlled by at least one spring urging the latch into the locked position.

The access port is any of a USB receiving port, a CD/DVD ROM access port, a flash card port, a SIM card port.

In one embodiment, the locking assembly has incorporated therein, at least one alarm device, said alarm device operatively associated with an actuator that initiates an alarm when said assembly is removed in any manner not utilizing said locking assembly holder. In one embodiment the alarm mechanism further has, operatively associated therewith, a transmitter that provides for transmitting a signal indicating the lacking assembly has been removed without first being unlocked.

The present invention further includes a method of locking a data access port, said method comprising:

providing a locking assembly and locking assembly holder of claim 1;

unlocking said locking assembly holder;

placing said locking assembly on said locking assembly holder;

placing said locking assembly in said data port; and

locking said locking assembly into position in said data port.

The method provides that said locking assembly has incorporated therein, at least one alarm device, said alarm device operatively associated with an actuator that initiates an alarm when said assembly is removed in any manner not utilizing said locking assembly holder, said method further comprising unlocking said assembly, wherein said unlocking disarms said alarm. The alarm device, in one embodiment, has a transmitter operatively associated therewith, which is constructed and arranged to transmit a signal to indicate the alarm assembly has been removed without being unlocked.

### BRIEF DESCRIPTION OF THE SEVERAL VIEWS OF THE DRAWING

FIG. 1 is a bottom perspective view of the lock mechanism of the present invention.

FIG. 2 is a side cross-section view of the lock assembly of the present invention.

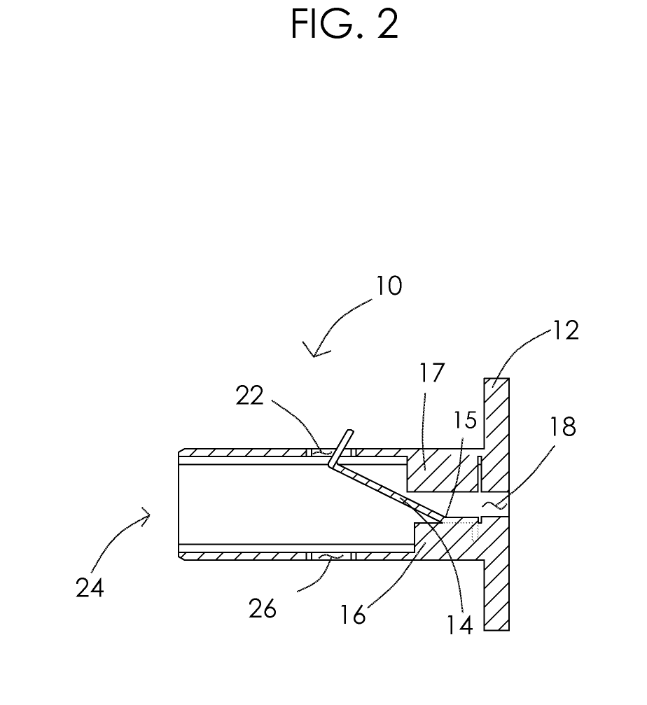

FIG. 3 is a perspective view of the lock mechanism of the perspective assembly and the directional arrow showing placement into a standard USB female receiving port.

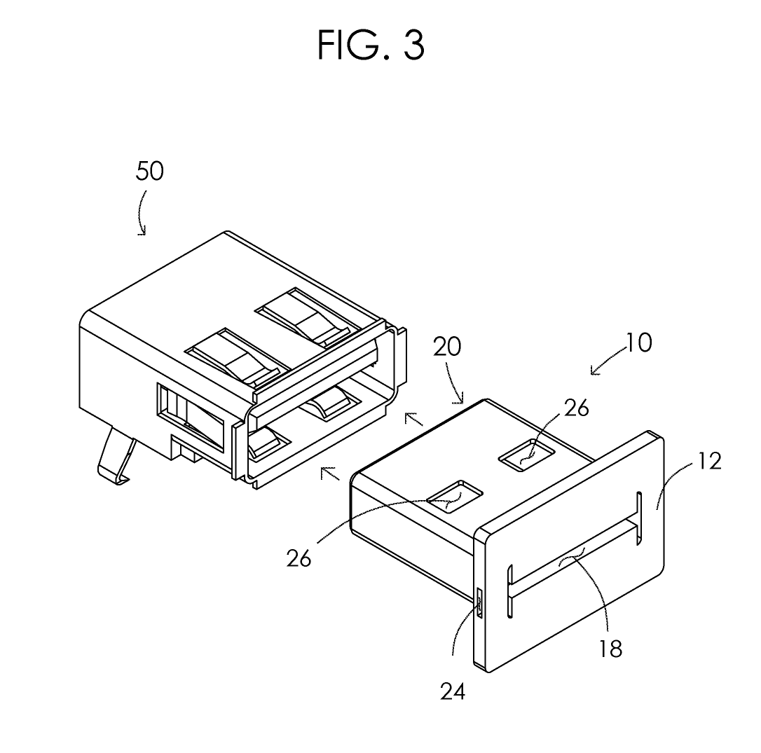

FIG. 4 is a side cross-section view of the lock assembly of the present invention and lock application unit.

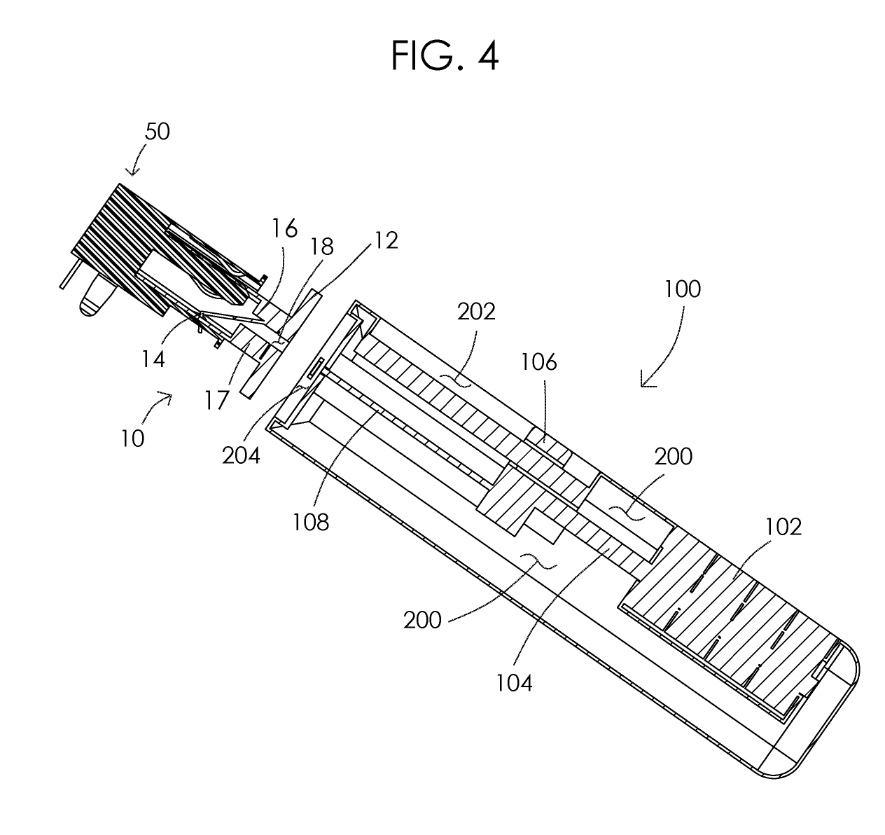

FIG. 5 is a side cross-section view of the lock assembly of the present invention and lock application unit with the latch moved by a latch unlock bar into an unlocked position.

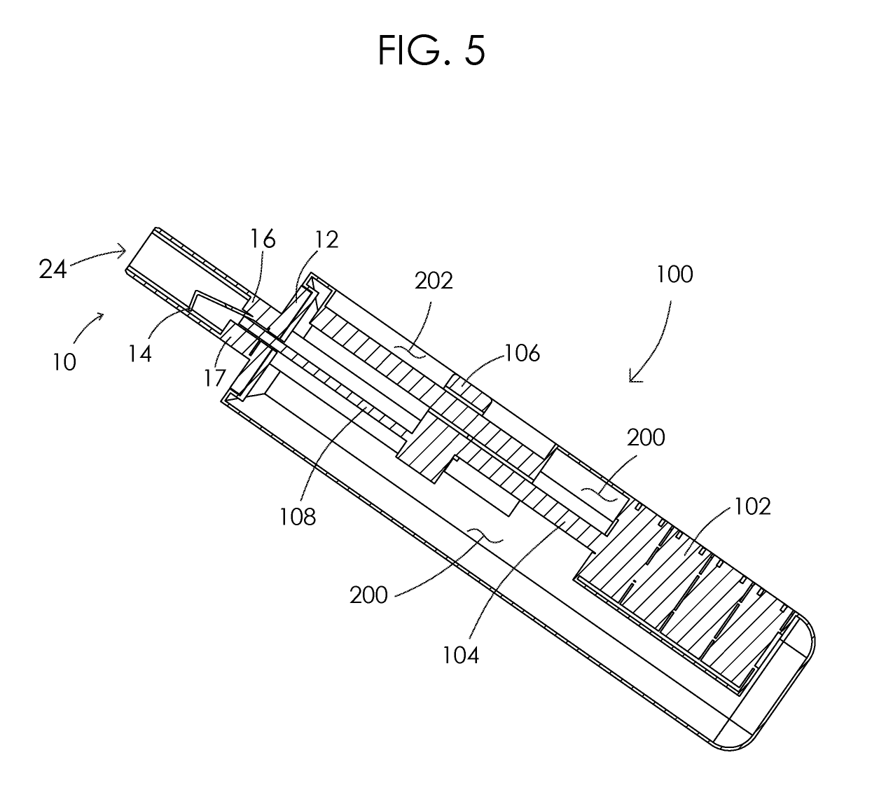

FIG. 6 is a top view of the lock positioning device and assembly of the present invention.

### DETAILED DESCRIPTION OF THE PREFERRED EMBODIMENT

In one embodiment, the present invention provides an improved system whereby a user can insert a lock assembly 10 into a conventional female USB receiver port 50 in order to restrict access to the USB receiver port 50. The present invention provides lock assembly 10 constructed and arranged with a first end placement plate 12 and a second end 20. Said second end 20 constructed and arranged such that lock assembly 10 is removably insertable into a standard USB receiving port 50.

Lock assembly 10 has formed therein a latch 14 that is dependent on a latch base 16. In a preferred embodiment, latch 14 is formed of a single unitary piece having a living hinge 15 formed thereon. The living hinge 15 urges latch 14 continually through latch opening 22 such that the terminal end of latch 14 secures lock assembly 10 into a fixed position when lock assembly 10 is inserted into a USB receiving port. Lock assembly 10 has formed hereon receiving cavity 26 constructed and arranged to interact, mate, and connect with conventional USB receiving ports.

The system further includes a lock positioning device 100 that is used to secure and remove lock assembly 10 into position. Lock positioning device 100 has a security lock incorporated thereon whereby only a user able to lock and unlock lock positioning device can apply and remove lock assembly 10.

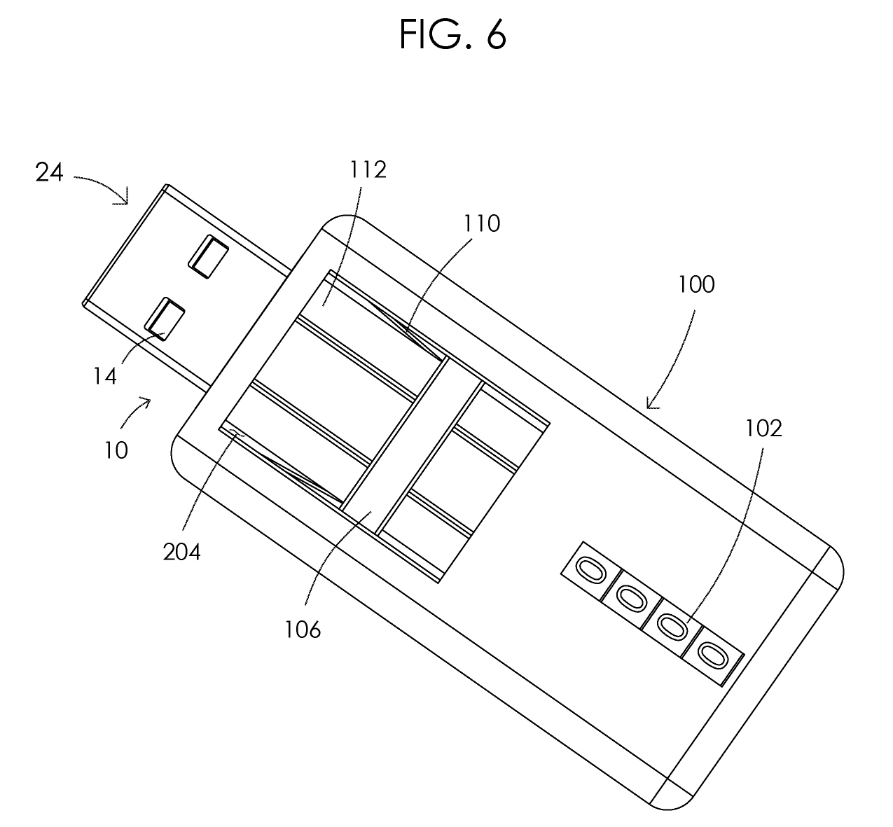

In one embodiment, as in FIG. 6, a series of rotatable dials 102 is incorporated into positioning device 100 which provides a user the ability to lock and unlock lock assembly 10 into position in USB port 50. A restrictor 104 prevents actuation of any unlocking mechanism until a lock incorporated with lock positioner 100 has been unlocked.

Although a dial lock is shown, lock positioning device 100 can have any suitable lock incorporated therewith. Suitable locks include but are not limited to, chamber lock, combination lock, cylinder lock, deadbolt, disc tumbler lock, electronic lock, electric strike lock, magnetic lock, mortise lock, keycard lock, lever tumbler lock, chub detector lock, protector lock, magnetic keyed lock, pin tumbler lock, RFID lock, rim lock, spring bolt lock, tubular pin tumbler lock, time lock, wafer tumbler lock, warded lock, and combinations thereof.

The impetus of the invention provides that a lock with an authorized user is able to use the lock positioner 100 and secure lock assembly 10 into position and subsequently remove lock mechanism 10 out of position as desired. Position, as understood herein refers to positioning lock assembly 10 in a USB receiving port 50.

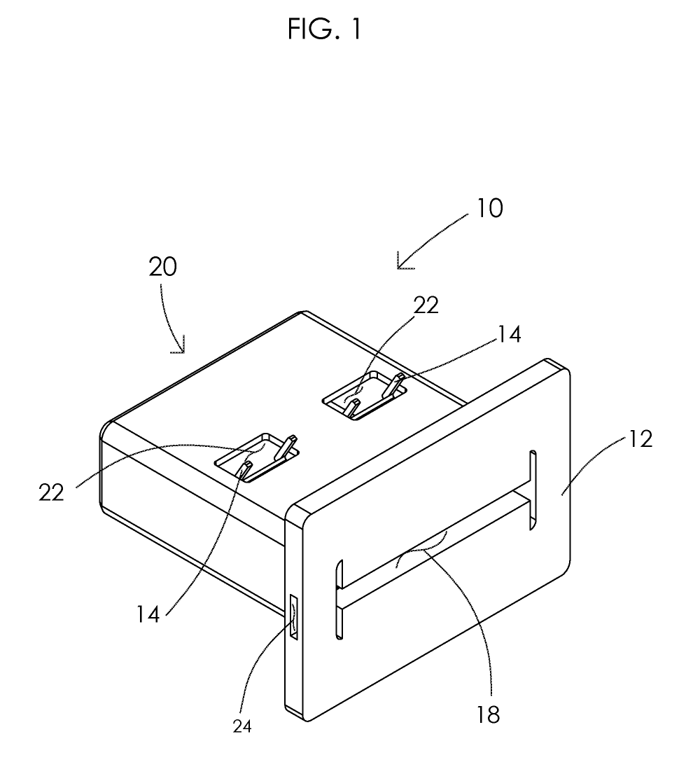

In one embodiment, lock mechanism 10 is constructed and arranged to be held onto lock positioner 100 by positioning plate 12 on holder 204 and securing with a grasping means or male-female interlock utilizing plate securing cavity 24 which can include one or more cavities incorporated on plate 12 about the perimeter, as seen in FIG. 1.

Lock positioner 100 positions lock assembly 10 such that second end 20 which is constructed and arranged to mate with a conventional USB receiver port 50 is unobstructed. When lock assembly 10 is attached to lock positioner 100, and lock positioner 100 is in an unlock position, latch 14 is urged away from latch cavity 22 into a position such that it does not extend through latch cavity 22. This allows lock mechanism to freely move inward and outward from a USB receiving port 50 from into which it is inserted.

When lock mechanism 10 is placed in a USB port a user will actuate the locking device using lock positioner 100. As stated above all types of locks, mechanical, electronic or otherwise are contemplated useful in the present invention.

A user will use a lock and actuate the lock applicator such that latch 14 locks into position and prevents lock mechanism 10 from being removed once inserted in a USB receiving port. When it is desired to remove lock mechanism 10, a user will again attach lock positioner 100, use an appropriate unlocking device, the unlocking device will disengage latch 14 and allow lock mechanism 10 to be removed from the USB receiving port into which it has been placed.

In one embodiment, interior cavity 200 of lock positioner 100 has a disengagement shaft 108. Shaft 108, when unlocked, is moved with slide plate 106 along channel 202. Shaft 108 extends through plate access cavity 18 and engages latch 14. Once latch 14 is engaged, by shaft 108, latch 14 is moved in position such that it is no longer urged through latch opening 22. This is an unlocked or disengaged latch position. Once latch 14 is disengaged, lock assembly 10 is removable and subsequently removed as desired from USB port 50.

Although as described herein, the device is constructed and arranged to be used with a USB port, the present invention is contemplated to work with all openings in which the electronics, storage and transfer of information in any computer or computer based device is accessed through an external port. This would include, but would not be limited to openings for CD ROM drives, flash cards, SIM cards, and the like. The locking mechanism is contemplated to be constructed and arranged to interact with any of these openings in order to insure that unauthorized access is not granted. It is further contemplated that lock mechanism 10 be constructed and arranged with an alarm actuator device 17 to alert removal without authorization. The placement and type of actuator 17 is contemplated as any electronic device to actuate an alert if lock mechanism 10 us removed without being unlocked.

Without authorization would mean when lock mechanism 10 is removed without using the unlocked component of lock applicator 100. The alarm includes, but is not limited to any of a light, a visual alarm, an audio alarm, an alarm broadcast to a receiver, whereby the receiver can be a computer, cell phone, SMS message, MMS, or combinations thereof. In one embodiment, lock mechanism 10 is constructed and arranged to broadcast a SMS or MMS text message. When it is removed without using lock applicator 100, a text message is sent to a predetermined number or numbers informing that the lock has been removed. This provides additional safety and security for data stored and limiting access to the transfer of said data.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for securing an information access port, said system comprising:
a locking assembly constructed and arranged to be removably placed into an information access port;
a locking assembly holder, whereby said locking mechanism holder is constructed and arranged with at least one locking device whereby said locking device controls placement and subsequent removal of said locking assembly.

2. The system of claim 1 whereby said locking assembly has incorporated therein at least one moveable latch for securing said locking mechanism into an access port.

3. The system of claim 1 wherein said locking assembly includes a moveable latch that is urged into the lock position by a living hinge.

4. The system of claim 1 wherein said access port is a USB receiving port, a CD/DVD ROM access port, a flash card port, a SIM card port.

5. The system of claim 1, wherein said locking assembly has incorporated therein, at least one alarm device, said alarm device operatively associated with an actuator that initiates an alarm when said assembly is removed in any manner not utilizing said locking assembly holder.

6. A method of locking a data access port, said method comprising:
providing a locking assembly and locking assembly holder of claim 1;
unlocking said locking assembly holder;
placing said locking assembly on said locking assembly holder;
placing said locking assembly in said data port; and
locking said locking assembly into position in said data port.

7. The method of claim 5, wherein said locking assembly has incorporated therein, at least one alarm device, said alarm device operatively associated with an actuator that initiates an alarm when said assembly is removed in any manner not utilizing said locking assembly holder, said method further comprising unlocking said assembly, wherein said unlocking disarms said alarm.
